(19) United States
(12) Patent Application Publication
(10) Pub. No.: US 2025/0318983 A1
(43) Pub. Date: Oct. 16, 2025

(54) Massage device

(71) Applicant: Dongguan Qunan Technology Co., Ltd., Dongguan (CN)

(72) Inventor: Bo Yan, Dongguan (CN)

(21) Appl. No.: 19/251,704

(22) Filed: Jun. 26, 2025

Related U.S. Application Data
(63) Continuation of application No. 18/914,299, filed on Oct. 14, 2024.
Application No. 18/914,299 is a continuation-in-part of application No. 18/401,691, filed on Jan. 1, 2024, now Pat. No. 12,144,775.
Application No. 18/401,691 is a continuation-in-part of application No. 18/372,701, filed on Sep. 26, 2023, now Pat. No. 11,957,634.
Application No. 18/372,701 is a continuation of application No. 18/118,749, filed on Mar. 8, 2023, now Pat. No. 11,771,619.

(30) Foreign Application Priority Data
Jan. 17, 2023 (CN) 202310081620.1
Feb. 28, 2023 (CN) 202310193022.3

(51) Int. Cl. A61H 19/00; A61H 23/02

(52) U.S. Cl. CPC A61H 19/30; A61H 19/44; A61H 23/0254; A61H 2201/1215; A61H 2201/149; A61H 2201/1676

(57) ABSTRACT

A massage device that includes a shell and a driving member is provided. The shell has an opening that defines a moving space for a massage member within the shell. The driving member is connected to the massage member and configured to cause the massage member to swing in opposite directions. The massage member has a first end that connects to the driving member and a second end that extends into the moving space. The driving member causes the second end of the massage member to swing up toward the top side of the moving space until the second end of the massage member reaches a first position outside the lateral walls of the shell, and to swing down toward the bottom side of the moving space until the second end of the massage member reaches a second position outside the lateral walls of the shell.

### CROSS-REFERENCE TO RELATED APPLICATIONS

This application is a continuation of U.S. patent application Ser. No. 18/914,299, filed on Oct. 14, 2024, which is a continuation in part of U.S. patent application Ser. No. 18/401,691, filed on Jan. 1, 2024, now issued as U.S. Pat. No. 12,144,775, which is a continuation in part of U.S. patent application Ser. No. 18/372,701, filed on Sep. 26, 2023, now issued as U.S. Pat. No. 11,957,634, which is a continuation of U.S. patent application Ser. No. 18/118,749, filed on Mar. 8, 2023, now issued as U.S. Pat. No. 11,771,619, which claims priority to Chinese Patent Application No. 202310081620.1, filed on Jan. 17, 2023, and Chinese Patent Application No. 202310193022.3, filed on Feb. 28, 2023. The contents of all the aforementioned applications, including any intervening amendments thereto, are hereby incorporated herein fully by reference.

### TECHNICAL FIELD

The present disclosure relates to the technical field of massage devices and, in particular, to a massage device for female.

### BACKGROUND

With the development of society and economy, the pace of life is getting faster and faster, and the pressure of work is getting higher and higher. Thus, the demand for physical relaxation is increasing, and a consumer-grade massage device is becoming popular.

The massage device in the related art generally includes a motor and a massage head that is driven by the motor. During operation, the massage head provides linear reciprocating motions to hit a part of the human body that needs to be massaged, such as the waist, the neck, and the like. Such massage device is relatively simple in action, and the massage head thereof is subject to the resistance of the massaged part of the human body during operation, thus rendering it difficult to provide a good massage effect, and accordingly making the massage experience not ideal.

### SUMMARY

An objective of the present disclosure is to provide a massage device that is capable of providing a good massage effect, thus improving the massage experience.

In one aspect of the present disclosure, a massage device is provided, the massage device includes: a shell configured to be inserted into a vagina along an insertion direction, a lateral wall of the shell is concaved inwardly and laterally relative to an outer lateral surface of the shell to define a moving space, the moving space is communicating with an outside environment out of the outer lateral surface of the shell, the lateral wall extends along the insertion direction of the shell; a driving member arranged in a chamber of the shell, the chamber is adjacent to and not communicating with the moving space; and a massage member connected to the driving member in a transmission way, the massage member being swingable in a lateral direction of the shell under the driving of the driving member, wherein when the massage member swings, a portion of the massage member is reciprocating to at least a first position inside the moving space of the shell and at least a second position in the outside environment out of the outer lateral surface of the shell.

In another aspect of the present disclosure, a massage device is provided. The massage device includes: a shell having an opening that defines a moving space for a massage member within the shell, such that the massage member is allowed to move from inside of the shell to an outside environment out of the shell, the shell further includes two lateral walls that extend along a length of the shell, such that left and right sides of the moving space in the longitudinal direction of the shell are covered by the two lateral walls and top and bottom sides of the moving space in the longitudinal direction of the shell are not covered by the lateral walls and are open to the outside environment out of the shell; and a driving member arranged in a first chamber of the shell, the first chamber being defined by an interior surface of the shell, and the driving member being connected to the massage member and configured to cause the massage member to swing in opposite directions. The massage member has a first end that connects to the driving member and a second end that extends into the moving space, the driving member causes the second end of the massage member to swing up toward the top side of the moving space until the second end of the massage member reaches a first position outside the lateral walls of the shell, and to swing down toward the bottom side of the moving space until the second end of the massage member reaches a second position outside the lateral walls of the shell, and in the first position, the second end of the massage member protrudes past the lateral walls of the shell to touch a first body part outside the moving space, and in the second position, the second end of the massage member protrudes past the lateral walls of the shell to touch a second body part outside the moving space that is opposite the first body part.

In some embodiments of the present disclosure, the first chamber is separated from the moving space via a separating wall that is located between the first chamber and the moving space, and the massage member includes an elastic body that extends into the moving space. In some embodiments of the present disclosure, t the massage member further includes a transmission rod configured, such that a front end of the transmission rod is inserted into the elastic body and a rear end of the transmission rod is connected to the driving member, and a middle portion of the transmission rod is rotatably connected to the shell, such that the elastic body is driven to swing relative to the shell. In some embodiments of the present disclosure, the driving member includes a driving motor and a wheel connected to the driving motor, the rear end of the transmission rod defines a sliding groove, and an eccentric rod extends outwardly from the wheel and slidably engages into the sliding groove.

In some embodiments of the present disclosure, the shell has an elongated shape, and includes a front portion and a rear portion, provided at two opposite ends of the shell, and a middle portion provided between the front portion and the rear portion, the opening is defined at the middle portion, and the first chamber is defined inside the rear portion.

In another aspect of the present disclosure, a massage device is provided. The massage device includes: a shell including a first end portion, a second end portion opposite the first end portion, and a middle portion connected with the first end portion and the second end portion, each of the first end portion and the middle portion being configured to be inserted into a vagina along a length of the shell, a motor arranged in the shell; a connecting shaft connected to the motor and movable by a drive of the motor; and an elastic body within the middle portion and coupled to the connecting shaft. The middle portion has a configuration that defines a moving space, the elastic body is, at least partially, positioned within the moving space and is movable within the moving space, such that opposite lateral walls of the elastic body do not contact the shell. In some embodiments of the present disclosure, the middle portion includes an opening which is open to a first outside environment above the shell, the elastic body is movable between a first position outside the shell and a second position inside the shell.

In some embodiments of the present disclosure, the opening is further open to a second outside environment below the shell, the elastic body is movable between the first position outside the shell, the second position inside the shell, and a third position outside the shell, in the first position, the elastic body protrudes past the middle portion of the shell toward the first outside environment to touch a first body part outside the moving space, and in the third position, the elastic body protrudes past the middle portion of the shell toward the second outside environment to touch a second body part outside the moving space that is opposite the first body part.

In another aspect of the present disclosure, a massage device is provided. The massage device includes: a shell configured to be inserted into a vagina along an insertion direction, the shell including a lateral wall extending along the insertion direction, the lateral wall having an opening that defines a moving space for a massage member within the shell, such that the massage member is allowed to move from inside the shell to an outside environment out of the shell; and a driving member arranged in the shell, wherein: the massage member has a first end that is coupled to the driving member and a second end that extends into the moving space, and the driving member causes the second end of the massage member to swingingly move toward a first direction away from the shell until the second end of the massage member reaches a first position outside the lateral wall of the shell, and to move backward in a second direction opposite the first direction after reaching the first position.

In some embodiments of the present disclosure, the second end of the massage member is capable of reaching a second position in the opening of the shell when the second end of the massage member swings in the second direction.

In some embodiments of the present disclosure, the opening runs through the lateral wall of the shell along the first and second directions, the second end of the massage member swings further in the second direction until reaching a third position outside of the lateral wall of the shell, in the first position, the second end of the massage member protrudes past the lateral wall of the shell to touch a first body part outside the moving space, and in the third position, the second end of the massage member protrudes past the lateral wall of the shell to touch a second body part outside the moving space that is opposite the first body part.

In some embodiments of the present disclosure, left and right sides of the moving space in the insertion direction of the shell are covered by the lateral wall, and top and bottom sides of the moving space in the insertion direction of the shell are not covered by the lateral wall, such that the top and bottom sides are open to the outside environment out of the shell.

In some embodiments of the present disclosure, the shell further includes a first end portion and a second end portion opposite the first end portion, the second end portion is located outside of the vagina when the first end portion is inserted into the vagina, and the opening is located between the first end portion and the second end portion.

In some embodiments of the present disclosure, the second end portion of the shell includes a first chamber for receiving the driving member, the first chamber is separated from the moving space via a separating wall, a hole is defined in the separating wall, and the first end of the massage member is inserted into the first chamber via the hole.

In some embodiments of the present disclosure, the second end is, at least partially, formed of an elastomer, the first end includes a rod which is coupled to the driving member and partially inserted into the elastomer, and a hardness of the rod is higher than a hardness of the elastomer.

In some embodiments of the present disclosure, the elastomer does not contact left and right sides of the moving space in the insertion direction of the shell when the second end is caused to swing up and down.

### BRIEF DESCRIPTION OF DRA WINGS

In order to illustrate the technical solution in embodiments of the present disclosure more clearly, the following briefly introduces accompanying drawings used in the description of the embodiments. Obviously, the accompanying drawings in the following description are only some embodiments of the present disclosure. Those of ordinary skill in the art can obtain other accompanying drawings from these accompanying drawings without any creative efforts.

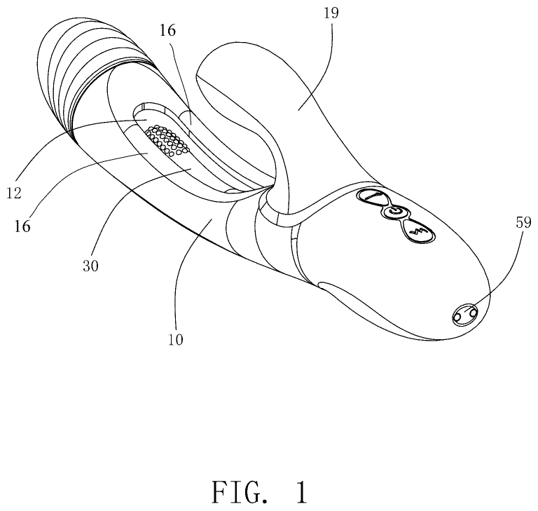

FIG. 1 is an isometric and assembled view of a massage device according to a first embodiment of the present disclosure.

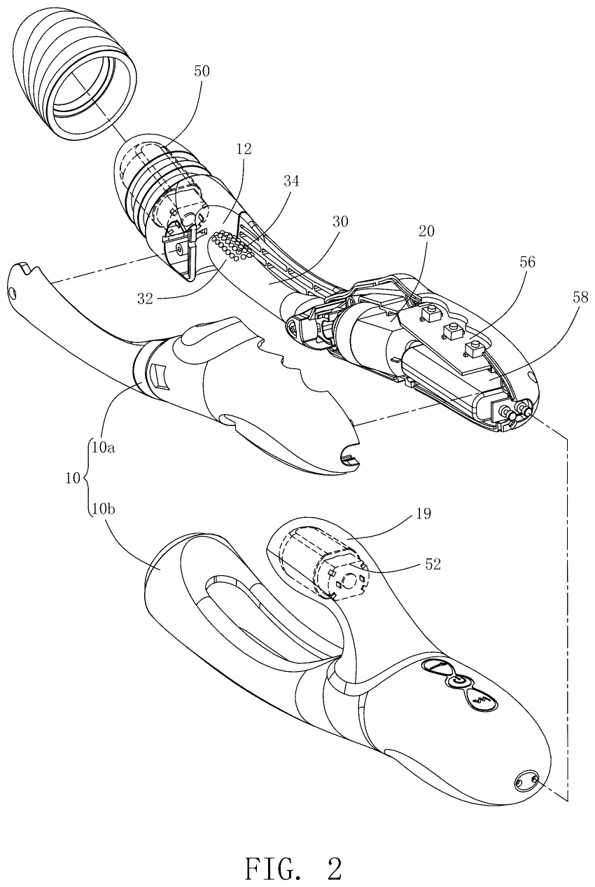

FIG. 2 is an isometric and exploded view of the massage device of FIG. 1.

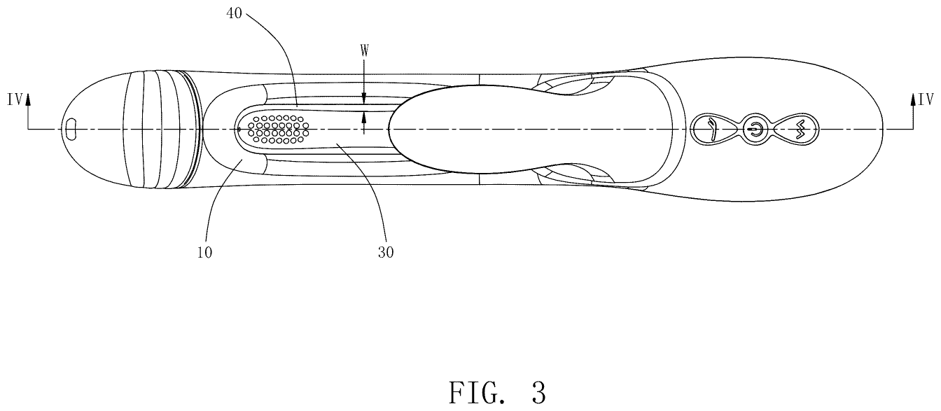

FIG. 3 is a top plane view of the massage device of FIG. 1.

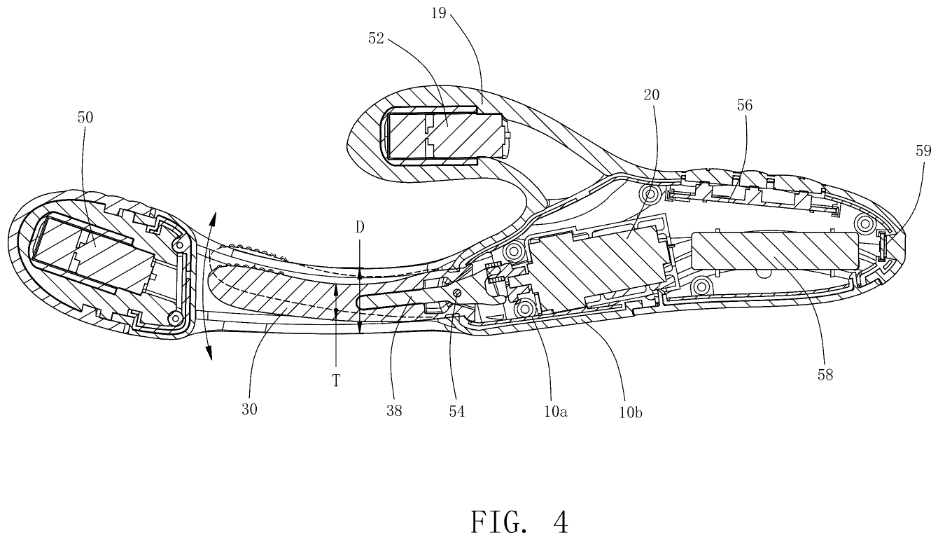

FIG. 4 is a cross sectional view of the massage device taken along ling IV-IV of FIG. 3.

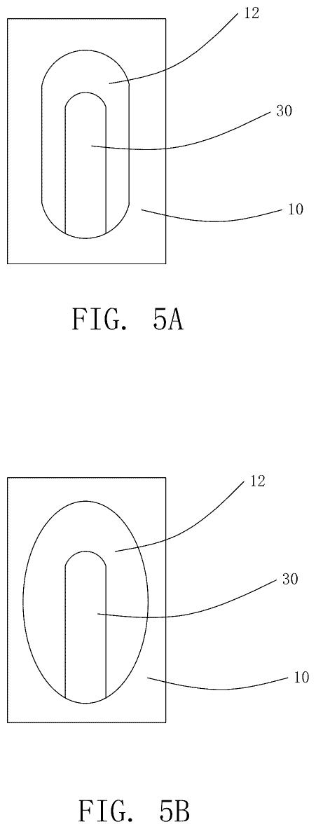

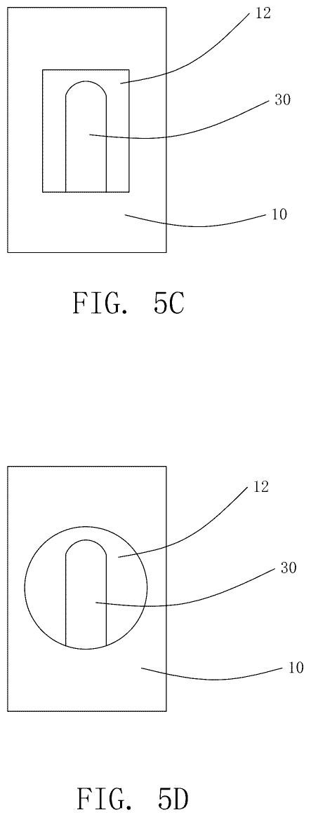

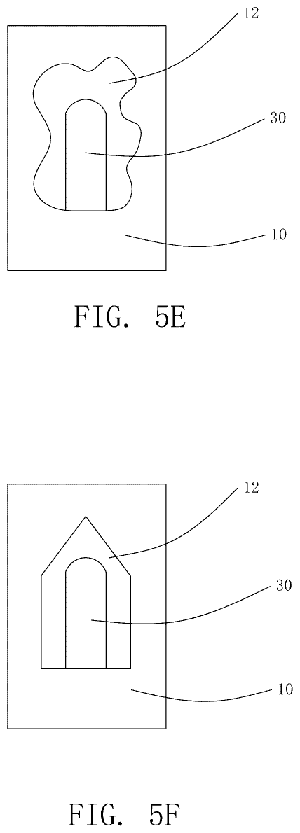

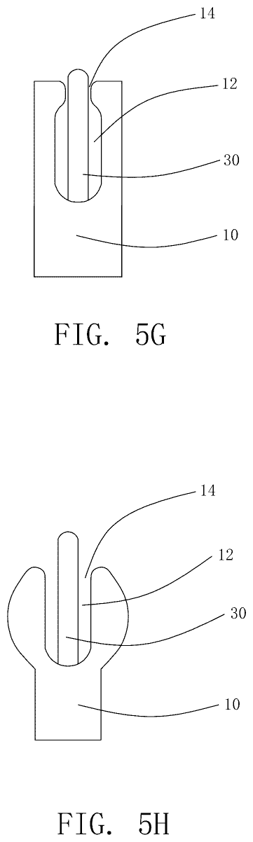

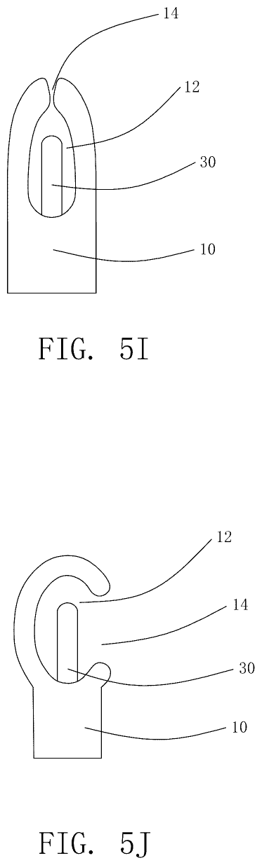

FIG. 5A is a schematic view of a moving space and a massage member of the massage device according to a first embodiment of the present disclosure.

FIG. 5B shows a second embodiment of the moving space according to the present disclosure.

FIG. 5C shows a third embodiment of the moving space according to the present disclosure.

FIG. 5D shows a fourth embodiment of the moving space according to the present disclosure.

FIG. 5E shows a fifth embodiment of the moving space according to the present disclosure.

FIG. 5F shows a sixth embodiment of the moving space according to the present disclosure.

FIG. 5G shows a seventh embodiment of the moving space according to the present disclosure.

FIG. 5H shows an eighth embodiment of the moving space according to the present disclosure.

FIG. 5I shows a ninth embodiment of the moving space according to the present disclosure.

FIG. 5J shows a tenth embodiment of the moving space according to the present disclosure.

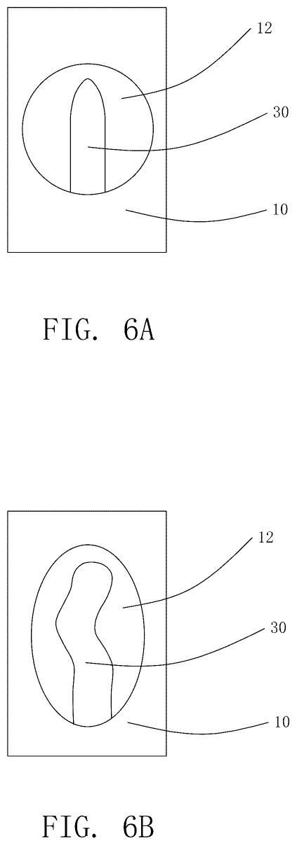

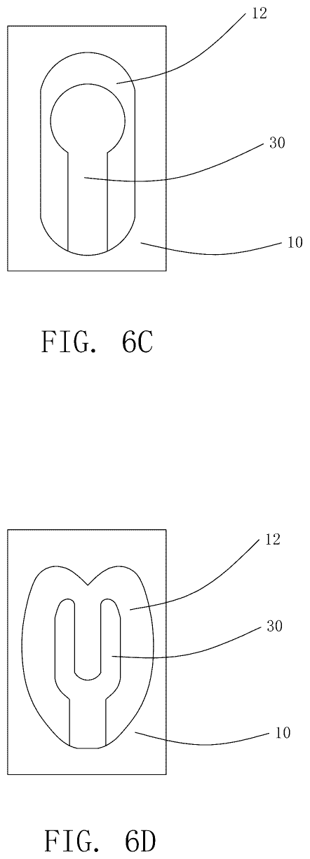

FIG. 6A shows a second embodiment of a massage member of the massage device according to the present disclosure.

FIG. 6B shows a third embodiment of the massage member according to the present disclosure.

FIG. 6C shows a fourth embodiment of the massage member according to the present disclosure.

FIG. 6D shows a fifth embodiment of the massage member according to the present disclosure.

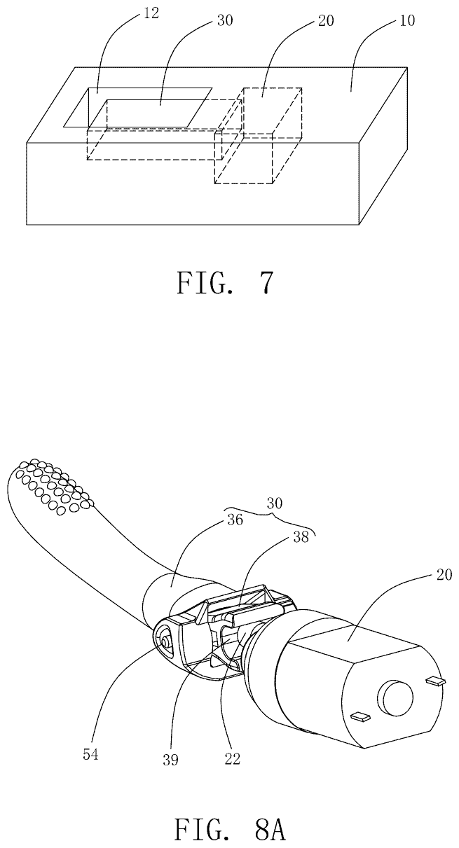

FIG. 7 is a schematic view of the massage device according to an alternative embodiment according to the present disclosure.

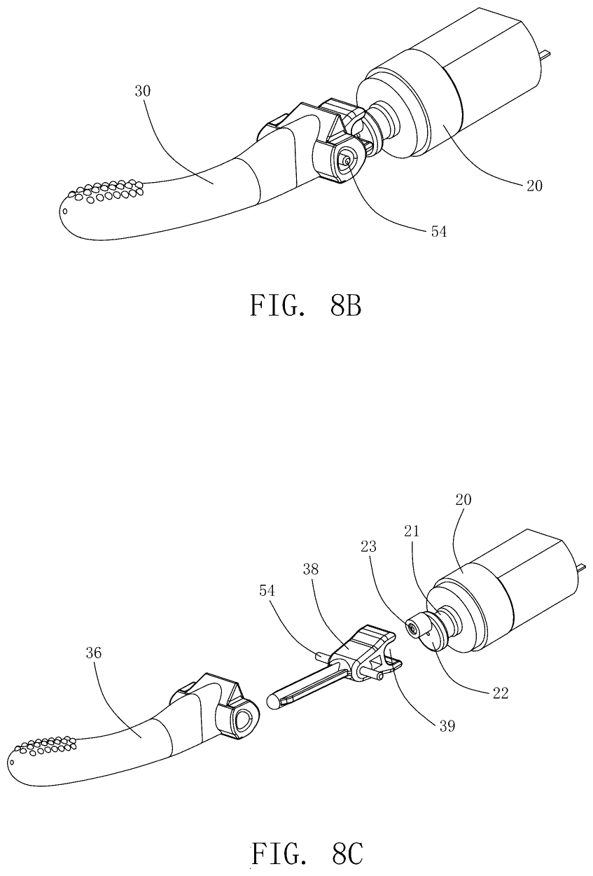

FIG. 8A is an isometric and assembled view of a massage module of the massage device of FIG. 1.

FIG. 8B shows the massage module of FIG. 8A from another perspective.

FIG. 8C is an exploded view of the massage module of FIG. 8B.

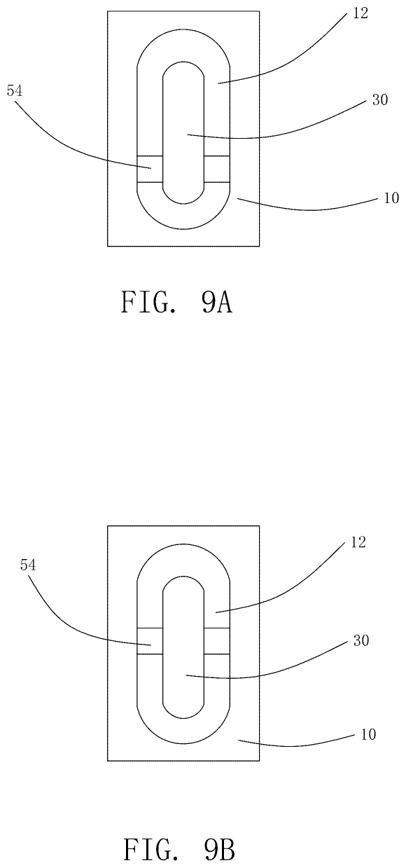

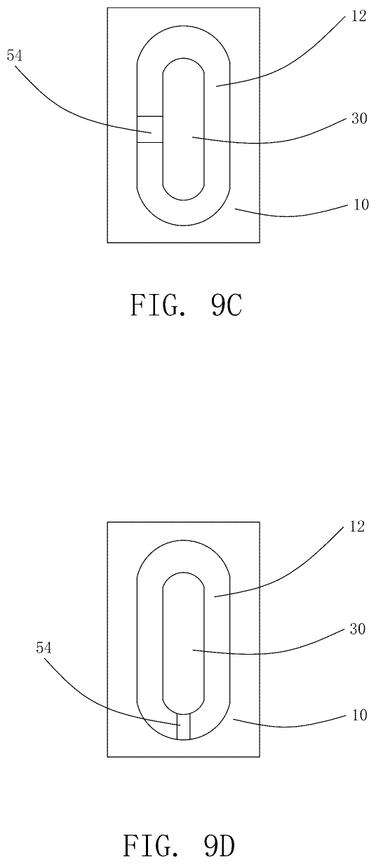

FIG. 9A shows a second embodiment of the massage module according to the present disclosure.

FIG. 9B shows a third embodiment of the massage module according to the present disclosure.

FIG. 9C shows a fourth embodiment of the massage module according to the present disclosure.

FIG. 9D shows a fifth embodiment of the massage module according to the present disclosure.

### DETAILED DESCRIPTION

In order to make those skilled in the art better understand the technical solution of the present disclosure, the technical solution in the embodiments of the present disclosure will be clearly and completely described below with reference to accompanying drawings in the embodiments of the present disclosure. Obviously, the described embodiments are only a part of the embodiments of the present disclosure, but not all of the embodiments. Based on the embodiments of the present disclosure, all other embodiments obtained by those skilled in the art without any creative efforts fall within the protection scope of the present disclosure.

It should be noted that when an element is said to be “connected” to another element, it may be directly connected to another element, or indirectly connected to another element through one or multiple intermediate elements.

In the specification, the oriental or positional relationships indicated by the terms “longitudinal”, “transverse”, “top”, “bottom”, “inner”, “outer”, “central”, “axial”, “radial”, “circumferential” and the like are only intended to facilitate the description of the present disclosure and simplify the description based on oriental or positional relationships shown in the accompanying drawings, not to indicate or imply that the apparatus or element referred must have a specific orientation, is constructed and operated in a specific orientation, and therefore cannot be understood as a limitation of the present disclosure.

Unless otherwise specified and limited, the specific meanings of all technical and scientific terms used in the specification can be specifically understood by persons of ordinary skill in the art. The terms used in the specification of this application is for the purpose of describing specific embodiments only and is not intended to limit this application.

Referring to FIG. 1 to FIG. 4, a massage device according an embodiment of the present disclosure is provided. The massage device includes a shell 10, a driving member 20 mounted in the shell 10 and a massage member 30 connected to the driving member 20 in a transmission way. The shell 10 defines a moving space 12 therein. The moving space 12 communicates with the outside environment. The massage member 30 extends into the moving space 12, and moves relative to the shell 10 under the action of the driving member 20. When the massage member 30 is moving, at least a portion of the massage member 30 is capable of extending beyond the moving space 12 of the shell 10 to the outside environment, so as to massage a corresponding part of the human body outside of the shell 10.

The massage device according to the embodiment of this disclosure defines the moving space 12 in the shell 10, the massage member 30 extends into the moving space 12, and the driving member 20 makes the massage member 30 move relative to the shell 10 in the form of swinging, so that at least a portion of the massage member 30, particularly, a free end of the massage member 30, swings beyond the moving space 12 of the shell 10 to hit the corresponding part of the human body outside of the shell 10, thus performing massage to the human body. The design of the moving space 12 in the shell 10 provides sufficient space for the swinging of the massage member 30, thus the massage device is capable of generating strong forces to the massaged part even under the resistance of the massaged part, and a good massage effect may be provided.

Preferably, the massage member 30 is an elastic structure and is capable of generating deformation when it hits the massaged part, so that the shape of the massage member 30, after being deformed, matches with the shape of the massaged part. In this way, a contact area of the massage member 30 and the massaged part is enlarged, thus the massage effect is further improved.

In some embodiments, the entire massage member 30 may be made of soft materials, such as silica, rubber and the like.

In some embodiments, an outer portion of the massage member 30 for touching the massaged part is made of soft materials, and an inner portion of the massage member 30 embedded in the outer portion is made of hard materials, such as plastic, metal and etc.

As shown in FIG. 4, the massage member 30 swings in the moving space 12 along the depth direction, i.e., swings in an up and down direction in the moving space 12. Preferably, the thickness T of the massage member 30 along the longitudinal direction is less than the depth D of the moving space 12 and/or the thickness of the shell 10 along the longitudinal direction, and the massage member 30 is completely received in the moving space 12 when it is not in operation. The thickness difference of the massage member 30 and the shell 10 provides a space therebetween along the swinging direction of the massage member 30, thus the massage member 30 is capable of swinging even when the massaged part is nestled to the outer surface of the shell 10, and the massage experience is ensured.

In this embodiment, the massage member 30 is generally elongated and column-shaped. The thickness T of the massage member 30 is preferably 1 mm˜150 mm, the width of the massage member 30 is preferably 1 mm˜150 mm, and the length of the massage member 30 is preferably 5˜150 mm, so as to make the touching area of the massage member 30 appropriate when it hits the massaged part. One end of the massage member 30 is connected to the driving member 20, and the other end of the massage member 30 is free. The free end of the massage member 30 acts as a massage head 32 that swings out of the moving space 12 to hit the massaged part. The entire massage member 30 is constructed as a single pendulum, and the massage head 32 may obtain a big swing amplitude even when the swing angle of the massage member 30 is small.

Preferably, a plurality of bulges 34 is formed on the outer surface of the massage head 32 of the massage member 30 for improving stimulation to the massaged part. Alternately, the bulges 34 may be formed on the entire outer surface of the massage member 30. Preferably, the bulges 34 are integrally formed with the massage member 30, for example by injection molding. Alternately, the bulges 34 may be formed separately and then assembled to the massage member 30 by bonding.

As shown in FIG. 3, the massage member 30 is less than the moving space 12 of the shell 10 in lateral dimensions, and a gap 40 is defined between an outer surface of the massage member 30 and an inner surface of the shell 10 surrounding the moving space 12. The gap 40 makes the swinging of the massage member 30 in the moving space 12 not interfere with the shell 10. On the one side, the width W of the gap 40 is designed to be not less than 0.5 mm to ensure that the massage member 30 swings freely in the moving space 12. On the other hand, the width W of the gap 40 is designed to be less than 100 mm to avoid wasting space and reduce the entire dimensions of the massage device. In specific embodiments, the width W of the gap 40 may be 0.5 mm, 1.5 mm, 3 mm, . . . , 50 mm, . . . , 99 mm or 100 mm.

In this embodiment, the moving space 12 has a shape similar to that of the massage member 30. The width W of the gap 40 between the outer surface of the massage member 30 and the inner surface of the shell 10 is substantially constant along a circumferential direction. Specifically, the moving space 12 is generally race-track shaped. The inner surface of the shell 10 is continuous along the circumferential direction and the moving space 12 is closed circumferentially.

In this embodiment, the moving space 12 is a through hole extending through two opposite sides (top and bottom sides, as viewed from FIG. 2) of the shell 10. In this case, the depth D of the moving space 12 is the same as the thickness of the shell 10, preferably ranges from 1 mm to 100 mm. During operation, the massage member 30 swings along the depth direction of the moving space 12, which includes not only swinging upwardly outside of the shell 10, but also swinging downwardly outside of the shell 10. That is, the massage member 30 is capable of massaging two different parts of the human body, which are located at two opposite sides of the shell 10 at the same time, thus rendering it more suitable for use in the human body to massage a cavity, such as the vagina.

In other embodiments, the moving space 12 may be a blind hole extending through only one side, such as the top side of the shell 10, as shown in FIG. 7. In this situation, the depth D of the moving space 12 is less than the thickness of the shell 10. The massage device with the blind hole is more suitable for massaging the body surface, such as the waist, the neck and the like. It should be noted that the massage device with the blind hole may also be used for massaging a cavity of the human body, and the massage device with the through hole may also be used for massaging a body surface.

In other embodiments, as shown in FIG. 5A to FIG. 6D, the moving space 12 may have a shape different from that of the massage member 30, and thus the width W of the gap 40 may be variable along the circumferential direction.

The shape of the moving space 12 may be regular or irregular, specifically, may be any one of circular, semicircular, elliptical, square, rectangular, triangular, polygonal, D-shaped, C-shaped, kidney-shaped, heart-shaped, gourd-shaped, briolette-shaped, and etc., or may be a combination of at least two examples thereof. For example, the moving space 12, as shown in FIG. 5A, is generally kidney-shaped, the moving space 12, as shown in FIG. 5B, is generally elliptical, the moving space 12, as shown in FIG. 5C, is generally rectangular, the moving space 12, as shown in FIG. 5D, is generally circular, the moving space 12, as shown in FIG. 5E, is generally irregular, the moving space 12, as shown in FIG. 5F, is generally a combination of a triangle and a rectangle. It should be understood that the shape of the moving space 12 may be set according to needs, which is not limited to the embodiments.

Further, the moving space 12 may be open in the circumferential direction. That is, the inner surface of the shell 10 surrounding the moving space 12 is discontinuous along the circumferential direction. As shown in FIGS. 5G and 5H, a circumferential opening 14 is defined in the shell 10 and communicates with the moving space 12. The circumferential opening 14 is aligned with the massage head 32 along the longitudinal direction of the massage member 30, and the massage head 32 extends out of the moving space 12 through the circumferential opening 14. In this case, not only the top and/or bottom sides, but also the massage head 32 of the massage member 30 are capable of hitting corresponding parts of the human body, which means that the area being massaged at the same time is further increased.

Alternately, the entire massage member 30 may be accommodated in the moving space 12 even when the moving space 12 is open circumferentially. FIG. 5I shows that the moving space 12 is generally briolette-shaped and open circumferentially, whilst the entire massage member 30 is in the moving space 12. In addition, the massage member 30 that is accommodated in the moving space 12 may be deviated from the circumferential opening 14. FIG. 5I shows that the moving space 12 is generally C-shaped, and the massage member 30 is generally column-shaped and arranged parallel to the circumferential opening 14 of the moving space 12.

The shape of the massage member 30 may be regular or irregular, specifically, may be any one of circular, semicircular, elliptical, square, rectangular, triangular, polygonal, D-shaped, C-shaped, kidney-shaped, heart-shaped, gourd-shaped, branch-shaped, and etc., or may be a combination of at least two examples thereof. For example, the massage member 30, as shown in FIG. 6A, is generally column-shaped with the massage head thereof being rounded, the massage member 30, as shown in FIG. 6B, is generally irregular, the massage member 30, as shown in FIG. 6C, is generally a combination of a column and a circle, and the massage member 30, as shown in FIG. 6D, is generally branch-shaped. It should be understood that the shape of the massage member 30 may be set according to needs, which is not limited to the embodiments.

The shape of the massage member 30 and the shape of the moving space 12 may be selected arbitrarily, as long as the massage member 30 is movable in the moving space 12. FIGS. 5A-5J show the moving spaces 12 of different shapes with the same massage member 30, and FIGS. 6A-6D show the moving spaces 12 of different shapes with the massage member 30 of different shapes. It should be noted that the present disclosure does not impose any restrictions on the shapes of the moving space 12 and massage member 30, and does not impose any restrictions on the combination of the shapes of the moving space 12 and massage member 30.

Referring to FIG. 1 again, the shell 10 is elongated and the moving space 12 is defined in a middle portion of the shell 10 along the longitudinal direction. Preferably, the moving space 12 in the middle portion of the shell 10 is closed circumferentially, and the shell 10 forms two supporting arms 16 at two opposite lateral sides (i.e., left and right sides) of the moving space 12. The supporting arms 16 enhance the strength of the shell 10, thus may provide effective support for the massage member 30 even when it swings rapidly and/or greatly. Preferably, the width of the supporting arm 16 ranges from 1 mm to 150 mm, which is conducive to the miniaturization of the massage device, particularly, miniaturization of the diameter of the massage device, so that the massage device may be used for massage of narrow and small parts, such as a cavity of the human body.

In some embodiments, as shown in FIGS. 6A-6D, the moving space 12 may be defined at an end portion of the shell 10. In this case, the moving space 12 may be closed in the circumferential direction or be open in the circumferential direction.

The shell 10 may be designed to have an outer profile according to its application scenarios. When the massage device is used in the human body, the shell 10 may be shaped as the cavity of the human body, for example, shaped as the vagina, as shown in FIGS. 1-4. When the massage device is used outside of the human body, the shell 10 may be any shape, such as column-shaped, block-shaped, disc-shaped, branch-shaped, and etc.

In some embodiments, the shell 10 may be provided with a handle for holding, thus facilitating the users to place the massage device onto any part of the human body. Alternately, the shell 10 may be provided with a wearable member, such as a telescopic belt, a bandage with a buckle, and the like. The whole massage device may be worn to the neck, the waist, the arm, the leg, and etc. through the wearable member, thus freeing hands of the users.

As shown in FIG. 2, in this embodiment, the shell 10 is a double-layer structure, which includes an inner shell 10a and an outer shell 10b covering the whole inner shell 10a. The inner shell 10a is made of hard materials, such as plastic, metal, wood, and etc. The outer shell 10b is made of soft materials, such as silicone, rubber, and etc. The inner shell 10a inside the outer shell 10b not only provides support for the outer shell 10b, but also provides a receiving space for mounting the driving member 20. The outer shell 10b, which is used to touch the massaged part directly, preferably has a smooth outer surface, thus the massage device, as a whole, has high strength and comfortable usage experience.

In this embodiment, the inner shell 10a is formed, by injection molding, as two pieces and then assembled together by snap-fitting, screws, and etc., which facilitates assembly of the elements inside the shell 10, such as the driving member 20. The outer shell 10b is formed, by 2nd injection molding, as one piece and covers the inner shell 10a after the inner shell 10a and the elements inside the inner shell 10a are assembled together. The integral outer shell 10b is beneficial to the waterproof and dustproof of the present message device, so that the message device may be used underwater or in a cavity of the human body.

In other embodiments, the inner shell 10a may be molded as one piece. In this case, elements that are mounted inside the inner shell 10a are arranged in the mold and then injects the inner shell 10a. Alternately, the outer shell 10b may be molded as two or more pieces and then assembled together. In this case, the shell 10 is detachable for replacing elements therein, which is good for maintenance of the massage device. The inner shell 10a may be the same as the outer shell 10b, thus the shell 10 has two different layers in any positions. Alternately, the inner shell 10a may be different from the outer shell 10b in local areas, thus the local areas of the shell 10 may be one layer, i.e., without the layer of the hard inner shell 10a.

Preferably, the moving space 12 is defined at a position of the hard outer shell 10b with the soft inner shell 10a formed therein, thus the solid portion surrounding the moving space 12 is constructed of two layers and the strength thereof is high enough to support the swinging of the massage member 30. It should be understood that in some cases where the requirements for the use environment are not high, the moving space 12 may be formed at a position of the outer shell 10b without the inner shell 10a formed therein.

In other embodiments, the shell 10 may be a single-layer structure with certain hardness.

Referring to FIGS. 2 and 4, the massage device further includes a vibration motor 50. The vibration motor 50 is arranged in a front end of the shell 10 for generating high-frequency vibration. When the massage device is used, for example, in the vaginal of the human body, the vibration motor 50 in the front end of the shell 10 generates a vibration effect to the vaginal wall, and the massage member 30 generates an scratch effect to the vaginal wall at the same time, which may multiply the stimulation effect to the users.

Preferably, the massage device includes two vibration motors 50, 52, one of which is arranged in the front end of the shell 10, and the other is arranged in a branch 19 of the shell 10. The branch 19 curvedly extends from a rear end of the moving space 12 of the shell 10 to an upper side of the massage member 30. When the massage device is used in the vagina, the vibration motor 50 in the front end of the shell 10 generates an vibration effect to the vaginal wall, the massage member 30 generates an scratch effect to the vaginal wall, and the vibration motor 52 in the branch 19 of the shell 10 generates the vibration effect to the clitoris, which may maximize the stimulation effect to the users.

Referring to FIGS. 8A-8C, the driving member 20 is used to generate power to make the massage member 30 move relative to the shell 10. The driving member 20 may be a motor, a cylinder, and the like. Preferably, the driving member 20 is a rotary motor or a linear motor. Preferably, a transmission member 22 is arranged between the driving member 20 and the massage member 30. The transmission member 22 may be a gear mechanism, a pulley mechanism, a crank mechanism, a cam mechanism, a turbine mechanism, and etc., which not only transmits power from the driving member 20 to the massage member 30, but also changes the movement mode therebetween, such as changing the rotation of the driving member 20 to the swinging of the massage member 30.

In this embodiment, the driving member 20 is a rotary motor and the transmission member 22 is a cam. The rotary motor 20, the cam 22, and the massage member 30 cooperatively construct a massage module. The rotary shaft 21 of the rotary motor 20 is connected to a central portion of the cam 22, and a driving shaft 23 extends out from a periphery of the cam 22 to connect the massage member 30. Both the rotary shaft 21 and driving shaft 23 extend generally parallel to the longitudinal direction of the shell 10, but the driving shaft 23 is eccentric with respect to the rotary shaft 21. During rotation of the driving shaft 23, the driving shaft 23 revolves around the rotary shaft 21 to generate movement along both the thickness direction and the width direction of the shell 10.

In other embodiments, the driving member 20 may be a linear motor, which has an output shaft rotationally connected to the massage member 30. During the reciprocating motion of the linear motor, it drives the massage member 30 to swing up and down. In this case, the massaged parts are massaged in the form of slapping. Alternately, the driving member 20 may be a vibration motor, which directly transmits vibration to the massage member 30.

In other embodiments, the driving member 20 and the massage member 30 may be connected in a transmission way but in a non-contact manner. For example, the driving member 20 may be in the form of an electromagnet, and the massage member 30 is connected to the driving member 20 by magnetic force. The polarity of the electromagnet is changed according to the current directions that are applied to driving member 20, making the magnetic force between the driving member 20 and the massage member 30 attract or repel each other, thus realizing the swing action of the massage member 30.

In this embodiment, the massage member 30 includes a soft cover 36 and a hard core 38 embedded in the soft cover 36. The hard core 38 defines a groove 39 at an end thereof adjacent to the driving member 20 for receiving the driving shaft 23, and the groove 39 is configured, such that movement of the driving shaft 23 along the thickness direction is limited, while movement of the driving shaft 23 along the width direction is allowed. For example, a size of the groove 39 in the width direction is much larger than the diameter of the driving shaft 23, and a size of the groove 39 in the thickness direction is equal to or slightly larger than the diameter of the driving shaft 23. In this way, the driving shaft 23 is capable of driving the hard core 38 to move upwardly and downwardly, in turn driving the massage member 30 to swing along the thickness direction to the outside environment.

Two opposite lateral sides of the hard core 38 are rotatably connected to the shell 10, preferably to the inner shell 10a by a pivot 54. The pivot 54 is arranged adjacent to the groove 39, thus the massage head 32 of the massage member 30 has a greater swing amplitude. Preferably, the hard core 38 has a length not less than a half of the soft cover 36. That is, the hard core 38, at least, extends to a middle portion of the soft cover 36, providing sufficient support for the soft cover 36 and being conducive to driving the swinging of the massage head 32 of the soft cover 36.

The massage member 30 that is connected to the shell 10 at a position adjacent to an end thereof that is connected to the driving member 20 makes the massage member 30 [[as]] a simple pendulum, so that the massage head 32 that is at the other end of the massage member 30 and away from the driving member 20 has a greater swing amplitude. In other embodiments, the massage member 30 may be connected to the shell 10 at a middle portion thereof, as shown in FIG. 9B. In addition, the massage member 30 may be connected to the shell 10 at one side, such as the left side, as shown in FIG. 9C. Further, as shown in FIG. 9D, the massage member 30 may be connected to the shell 10 at a distal end thereof.

Referring to FIGS. 2 and 4 again, the massage device further has a control member 56, such as a control circuit board, mounted in the shell 10. The control member 56 is electrically connected to the rotary motor 20 and the vibration motors 50, 52 for controlling their operations according to the user's instructions, such as controlling the frequency of the vibration motors 50, 52, controlling the rotary speed of the rotary motor 20, and etc.

Preferably, a battery 58 is arranged in the shell 10 and connected to the circuit board 56 electrically. The battery 58 supplies electric power to the motors 20, 50, 52 through the circuit board 56. Preferably, the battery 58 is a rechargeable battery, and a corresponding charging interface 59 may be provided at a rear end of the shell 10 to connect external power supply to charge the battery 58.

The massage device according to the embodiment of this disclosure defines the moving space 12 in the shell 10 for providing sufficient space for the swinging of the massage member 30, so that the massage device 30 is capable of generating a strong force to the massaged part even under the resistance of the massaged part, thus providing a good massage effect. Further, the present massage device is provided with vibration motors 50, 52 for generating a high high-frequency vibration, further improving the massage effect.

Finally, it should be noted that the above merely describes preferred embodiments of the present disclosure without intention to limit the scope of the present disclosure. Although the present disclosure has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present disclosure should be within the scope of the present disclosure.

What is claimed is:

1. A massage device, comprising:
a shell having an opening that defines a moving space for a massage member within the shell, such that the massage member is allowed to move from inside of the shell to an outside environment out of the shell, wherein the shell further comprises two lateral walls that extend along a length of the shell, such that left and right sides of the moving space in the longitudinal direction of the shell are covered by the two lateral walls and top and bottom sides of the moving space in the longitudinal direction of the shell are not covered by the lateral walls and are open to the outside environment out of the shell; and
a driving member arranged in a first chamber of the shell, the first chamber being defined by an interior surface of the shell, and the driving member being connected to the massage member and configured to cause the massage member to swing in opposite directions, wherein:
the massage member has a first end that connects to the driving member and a second end that extends into the moving space,
the driving member causes the second end of the massage member to swing up toward the top side of the moving space until the second end of the massage member reaches a first position outside the lateral walls of the shell, and to swing down toward the bottom side of the moving space until the second end of the massage member reaches a second position outside the lateral walls of the shell, and
in the first position, the second end of the massage member protrudes past the lateral walls of the shell to touch a first body part outside the moving space, and in the second position, the second end of the massage member protrudes past the lateral walls of the shell to touch a second body part outside the moving space that is opposite the first body part.

2. The massage device according to claim 1, wherein:
the first chamber is separated from the moving space via a separating wall that is located between the first chamber and the moving space, and
the massage member comprises an elastic body that extends into the moving space.

3. The massage device according to claim 2, wherein:
the massage member further comprises a transmission rod configured, such that a front end of the transmission rod is inserted into the elastic body and a rear end of the transmission rod is connected to the driving member, and
a middle portion of the transmission rod is rotatably connected to the shell, such that the elastic body is driven to swing relative to the shell.

4. The massage device according to claim 3, wherein:
the driving member comprises a driving motor and a wheel connected to the driving motor,
the rear end of the transmission rod defines a sliding groove, and
an eccentric rod extends outwardly from the wheel and slidably engages into the sliding groove.

5. The massage device according to claim 1, wherein:
the shell has an elongated shape, and comprises a front portion and a rear portion, provided at two opposite ends of the shell, and a middle portion provided between the front portion and the rear portion,
the opening is defined at the middle portion, and
the first chamber is defined inside the rear portion.

6. A massage device, comprising:
a shell including a first end portion, a second end portion opposite the first end portion, and a middle portion connected with the first end portion and the second end portion, each of the first end portion and the middle portion being configured to be inserted into a vagina along a length of the shell,
a motor arranged in the shell;
a connecting shaft connected to the motor and movable by a drive of the motor; and
an elastic body within the middle portion and coupled to the connecting shaft, wherein:
the middle portion has a configuration that defines a moving space,
the elastic body is, at least partially, positioned within the moving space and is movable within the moving space, such that opposite lateral walls of the elastic body do not contact the shell.

7. The massage device according to claim 6, wherein:
the middle portion includes an opening which is open to a first outside environment above the shell,
the elastic body is movable between a first position outside the shell and a second position inside the shell.

8. The massage device according to claim 7, wherein:
the opening is further open to a second outside environment below the shell,
the elastic body is movable between the first position outside the shell, the second position inside the shell, and a third position outside the shell,
in the first position, the elastic body protrudes past the middle portion of the shell toward the first outside environment to touch a first body part outside the moving space, and
in the third position, the elastic body protrudes past the middle portion of the shell toward the second outside environment to touch a second body part outside the moving space that is opposite the first body part.

9. A massage device comprising:
a shell configured to be inserted into a vagina along an insertion direction, the shell including a lateral wall extending along the insertion direction, the lateral wall having an opening that defines a moving space for a massage member within the shell, such that the massage member is allowed to move from inside the shell to an outside environment out of the shell; and
a driving member arranged in the shell, wherein:
the massage member has a first end that is coupled to the driving member and a second end that extends into the moving space, and
the driving member causes the second end of the massage member to swingingly move toward a first direction away from the shell until the second end of the massage member reaches a first position outside the lateral wall of the shell, and to move backward in a second direction opposite the first direction after reaching the first position.

10. The massage device according to claim 9, wherein:
the second end of the massage member is capable of reaching a second position in the opening of the shell when the second end of the massage member swings in the second direction.

11. The massage device according to claim 10, wherein:
the opening runs through the lateral wall of the shell along the first and second directions,
the second end of the massage member swings further in the second direction until reaching a third position outside of the lateral wall of the shell,
in the first position, the second end of the massage member protrudes past the lateral wall of the shell to touch a first body part outside the moving space, and
in the third position, the second end of the massage member protrudes past the lateral wall of the shell to touch a second body part outside the moving space that is opposite the first body part.

12. The massage device according to claim 11, wherein:
left and right sides of the moving space in the insertion direction of the shell are covered by the lateral wall, and
top and bottom sides of the moving space in the insertion direction of the shell are not covered by the lateral wall, such that the top and bottom sides are open to the outside environment out of the shell.

13. The massage device according to claim 9, wherein:
the shell further comprises a first end portion and a second end portion opposite the first end portion,
the second end portion is located outside of the vagina when the first end portion is inserted into the vagina, and
the opening is located between the first end portion and the second end portion.

14. The massage device according to claim 13, wherein:
the second end portion of the shell includes a first chamber for receiving the driving member,
the first chamber is separated from the moving space via a separating wall,
a hole is defined in the separating wall, and
the first end of the massage member is inserted into the first chamber via the hole.

15. The massage device according to claim 9, wherein:
the second end is, at least partially, formed of an elastomer,
the first end comprises a rod which is coupled to the driving member and partially inserted into the elastomer, and
a hardness of the rod is higher than a hardness of the elastomer.

16. The massage device according to claim 15, wherein:
the elastomer does not contact left and right sides of the moving space in the insertion direction of the shell when the second end is caused to swing up and down.
